(19) United States
(12) Patent Application Publication
(10) Pub. No.: US 2014/0369340 A1
(43) Pub. Date: Dec. 18, 2014

(54) METHOD AND DEVICES FOR RADIO LINK MONITORING

(71) Applicant: Michael HORVAT, Muenchen (DE)

(72) Inventor: Michael HORVAT, Muenchen (DE)

(21) Appl. No.: 13/916,965

(22) Filed: Jun. 13, 2013

(51) Int. Cl. H04W 56/00

(52) U.S. Cl. CPC H04W 56/0005
USPC 370/350

(57) ABSTRACT

A method for radio link monitoring includes: weighting a sequence of signal-to-noise ratios of the radio link with a weighting function of the sequence of signal-to-noise ratios; and monitoring an average of the weighted sequence of signal-to-noise ratios of the radio link.

### TECHNICAL FIELD

The disclosure relates to methods and devices for radio link monitoring, in particular to radio link monitoring of data symbols encoded by orthogonal frequency division multiplex (OFDM) techniques according to 3GPP LTE standardization.

### BACKGROUND

Loss of synchronization detection is one of the crucial Radio Link Monitoring tasks by every user equipment (UE). Uplink transmission of an unsynchronized UE jeopardizes neighbor UE uplinks and the overall network performance. Therefore, 3rd Generation Partnership Project (3GPP) has specified In-Sync (in synchronization) and Out-of-Sync (out of synchronization) requirements in technical specification 3GPP TS 36.133 V11.4.0. The UE shall monitor the downlink link quality based on the cell-specific reference signal in order to detect the downlink radio link quality. The UE shall estimate the downlink radio link quality and compare it to the thresholds Qₒᵤₜ and Qᵢₙ for the purpose of monitoring downlink radio link quality. Whereas the In-Sync requirement is only tested for the ETU70 selective fading channel as defined by 3GPP TS 36.101 V11.4.0 B.2, the Out-of-Sync requirement is tested for AWGN and ETU70 channels. Thus, testing results in the UE depend on the used channel model requiring a computational complex classification of the underlying channel scenario by the UE.

### BRIEF DESCRIPTION OF THE DRAWINGS

The accompanying drawings are included to provide a further understanding of aspects of the disclosure and are incorporated in and constitute a part of this specification. The drawings illustrate aspects and together with the description serve to explain principles of aspects. Other aspects and examples and many of the intended advantages of aspects and examples will be readily appreciated as they become better understood by reference to the following detailed description. Like reference numerals designate corresponding similar parts.

FIG. 1 illustrates a flow diagram of an exemplary method for radio link monitoring.

FIG. 2 illustrates a graph depicting exemplary SNR distributions of an AWGN channel and an ETU70 channel and an exemplary weighting function.

FIG. 3 illustrates a graph depicting exemplary weighted SNR distributions of the AWGN channel and the ETU70 channel as depicted in FIG. 2 after the weighting with the weighting function.

FIG. 4 illustrates an example of a radio link monitoring device.

FIG. 5 illustrates a flow diagram of an exemplary method for detecting synchronization events in a radio link.

FIG. 6 illustrates a graph depicting exemplary SNR distributions of an AWGN channel and an ETU70 channel and exemplary block error rates of an AWGN channel and an ETU70 channel.

FIG. 7 illustrates a flow diagram of an exemplary method for generating SNR distributions and block error rates.

FIG. 8 illustrates a graph depicting exemplary SNR distributions of an AWGN channel and an ETU70 channel, an exemplary block error rate used as weighting function and an exemplary average after weighting.

FIG. 9 illustrates a flow diagram of an exemplary method for generating a threshold for detection of synchronization events.

### DETAILED DESCRIPTION

The aspects and examples are described with reference to the drawings, wherein like reference numerals are generally utilized to refer to like elements throughout. In the following description, for purposes of explanation, numerous specific details are set forth in order to provide a thorough understanding of one or more aspects or examples. It may be evident, however, to one skilled in the art that one or more aspects or examples may be practiced with a lesser degree of the specific details. In other instances, known structures and elements are shown in schematic form in order to facilitate describing one or more aspects or examples. It is to be understood that other examples may be utilized and structural or logical changes may be made without departing from the scope of the disclosure.

In addition, while a particular feature or aspect of an example may be disclosed with respect to only one of several implementations, such feature or aspect may be combined with one or more other features or aspects of the other implementations as may be desired and advantageous for any given or particular application. Furthermore, to the extent that the terms “include”, “have”, “with” or other variants thereof are used in either the detailed description or the claims, such terms are intended to be inclusive in a manner similar to the term “comprise”. The terms “coupled” and “connected”, along with derivatives may be used. It should be understood that these terms may be used to indicate that two elements co-operate or interact with each other regardless whether they are in direct physical or electrical contact, or they are not in direct contact with each other. Also, the term “exemplary” is merely meant as an example, rather than the best or optimal. The following detailed description, therefore, is not to be taken in a limiting sense, and the scope of the present disclosure is defined by the appended claims.

The following terms, abbreviations and notations will be used herein:
LTE: Long Term Evolution.
CRS: cell specific reference signal, e.g. as defined in 3GPP LTE.
RF: Radio Frequency.
UE: User Equipment.
PDCCH: physical downlink control channel.
PCFICH: physical control format indicator channel.
AWGN: additional white Gaussian noise channel, e.g. as defined in 3GPP TS 36.101 V11.4.0.
MBSFN: multicast/broadcast over single frequency network, e.g. as defined in 3GPP TS 36.101 V11.4.0.
EVA: extended vehicular A channel, e.g. as defined in 3GPP TS 36.101 V11.4.0.
ETU: extended typical urban channel, e.g. as defined in 3GPP TS 36.101 V11.4.0.
EPA: extended pedestrian A channel, e.g. as defined in 3GPP TS 36.101 V11.4.0.
BLER: block error rate, BLER is a ratio of the number of erroneous blocks to the total number of received blocks. BLER is used in LTE/4G technology to know the in-sync or out-of-sync indication during radio link monitoring (RLM). Normal in-sync condition is 2% of BLER and for out-of-sync is 10%.
SNR: signal-to-noise ratio, is defined as the power ratio between a signal (meaningful information) and the background noise (unwanted signal). SNR may refer to configured SNR for the respective simulation or measurement.
SINR: signal-to-interference-and-noise ratio, is Signal to Interference plus Noise Ratio that is calculated as SINR=P/(I+N) where P is signal power, I is interference power and N is noise power. SINR may refer to a noisy estimate for any particular SNR iteration.
In-sync: in synchronization state, e.g. as defined in 3GPP TS 36.133 V11.4.0
Out-of-Sync: out of synchronization state, e.g. as defined in 3GPP TS 36.133 V11.4.0, also denoted as SyncLoss state
RLM: radio link monitoring.
Discriminator: denotes the weighting function applied for weighting the sequence of signal-to-noise values, also denoted as discrimination function because higher SNR values are discriminated.

The devices and methods as described herein can be utilized as part of and for radio transmission systems, namely for systems operating in the Orthogonal Frequency Division Multiplex (OFDM) mode. The devices disclosed may be embodied in baseband segments of devices used for the transmission or reception of OFDM radio signals, in particular base stations, relay stations, mobile phones, hand-held devices or other kinds of mobile radio receivers. The described devices may be employed to perform methods as disclosed herein, although those methods may be performed in any other way as well.

The following description may be read in connection with any kind of multiple carrier radio transmission systems, in particular any mobile communications systems employing multiple carrier modulation, such as, for example, the Universal Mobile Telecommunications System (UMTS) Standard or the Long Term Evolution (LTE) Standard.

The following description may also be read in connection with multiple carrier radio transmission systems in the field of digital video broadcasting (DVB-T/H) which is based on terrestrial transmitters and a communication system design adapted for mobile or hand-held receivers. However, also other communications systems, for example, satellite OFDM systems or digital subscriber line (DSL) systems, may benefit from the concepts and principles outlined herein.

The devices and methods as described herein can be applied with respect to cell-specific reference signals. Cell-specific reference signals are transmitted in all downlink subframes in a cell supporting PDSCH transmission. Cell-specific reference signals are transmitted on one or several of antenna ports 0 to 3. Each antenna port has a unique cell specific reference signal associated with it. To facilitate the estimation of the channel characteristics LTE uses cell specific reference signals (pilot symbols) inserted in both time and frequency. These pilot symbols provide an estimate of the channel at given locations within a sub-frame. Through interpolation it is possible to estimate the channel across an arbitrary number of sub-frames. Cell-specific RS is transmitted in each physical antenna port. It is used for both demodulation and measurement purpose. Its pattern design ensures channel estimation accuracy. Cell-specific reference signals can be used for cell search and initial acquisition, downlink channel estimation for coherent demodulation/detection at the UE and downlink channel quality measurements.

The methods and devices as described herein may be utilized with any sort of antenna configurations employed within the multiple carrier radio transmission system as described herein. In particular, the concepts presented herein are applicable to radio systems employing an arbitrary number of transmit and/or receive antennas, that is Single Input Single Output (SISO) systems, Single Input Multiple Output (SIMO) systems, Multiple Input Single Output (MISO) systems and Multiple Input Multiple Output (MIMO) systems.

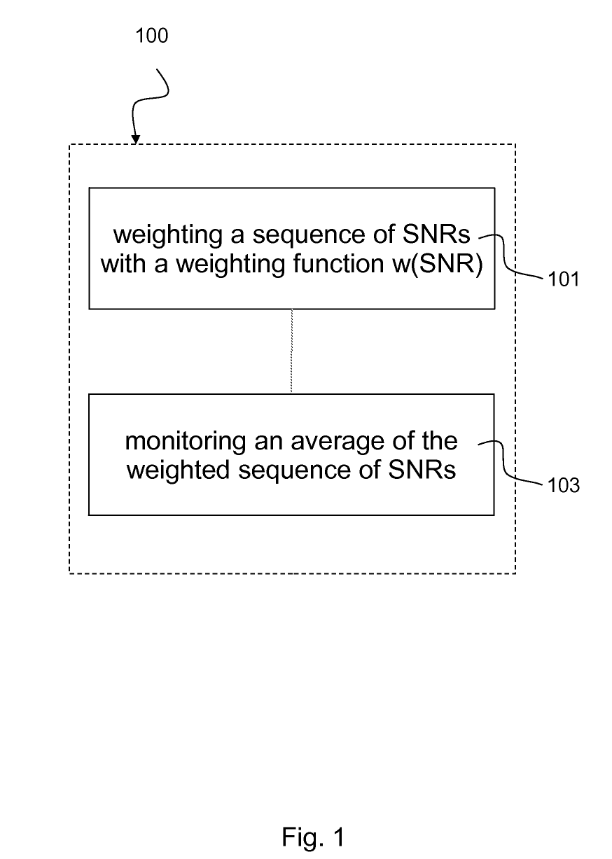

Referring to FIG. 1, a flow diagram of an exemplary method 100 for radio link monitoring is shown.

The method 100 comprises weighting 101 a sequence of signal-to-noise ratios of the radio link with a weighting function of the sequence of signal-to-noise ratios. The method 100 comprises monitoring 103 an average of the weighted sequence of signal-to-noise ratios of the radio link. By weighting 101 the sequence of signal-to-noise ratios, i.e. the SNR values, with a weighting function, the SNR distribution of the SNR values can be transformed to a transformed distribution having a shape of higher symmetry than the original distribution. A weighting function can be determined that transforms different original distributions, e.g. distributions of different channels, e.g. multipath fading channels of mobile radio transmission, to approximately the same transformed distributions. For these transformed distributions, the same threshold can be applied for detecting synchronization events. The sequence may also be a set e.g. the set may be arranged in time (in different OFDM symbols of different subframes), frequency (on different subcarriers of different resource blocks) or space (on different antennas or spatial layers), in the following the word sequence is used interchangeably.

In one example, the method 100 comprises detecting a synchronization event if the average of the weighted sequence of signal-to-noise ratios of the radio link crosses a threshold. Averaging the transformed, i.e. weighted sequence of SNRs provides a higher degree of reliability than using instantaneous values. In one example, the method 100 comprises determining the sequence of signal-to-noise ratios of the radio link based on a cell-specific reference signal. Determining the sequence of signal-to-noise ratios based on a CRS facilitates the estimation of the channel characteristics. The methods and devices can be applied in LTE systems which use cell specific reference signals (pilot symbols) inserted in both time and frequency. Using CRS provides an estimate of the channel at given locations within a sub-frame. Through interpolation it is possible to estimate the channel across an arbitrary number of sub-frames. Cell-specific RS is transmitted in each physical antenna port. It is used for both demodulation and measurement purpose. Methods and devices using CRS ensure channel estimation accuracy.

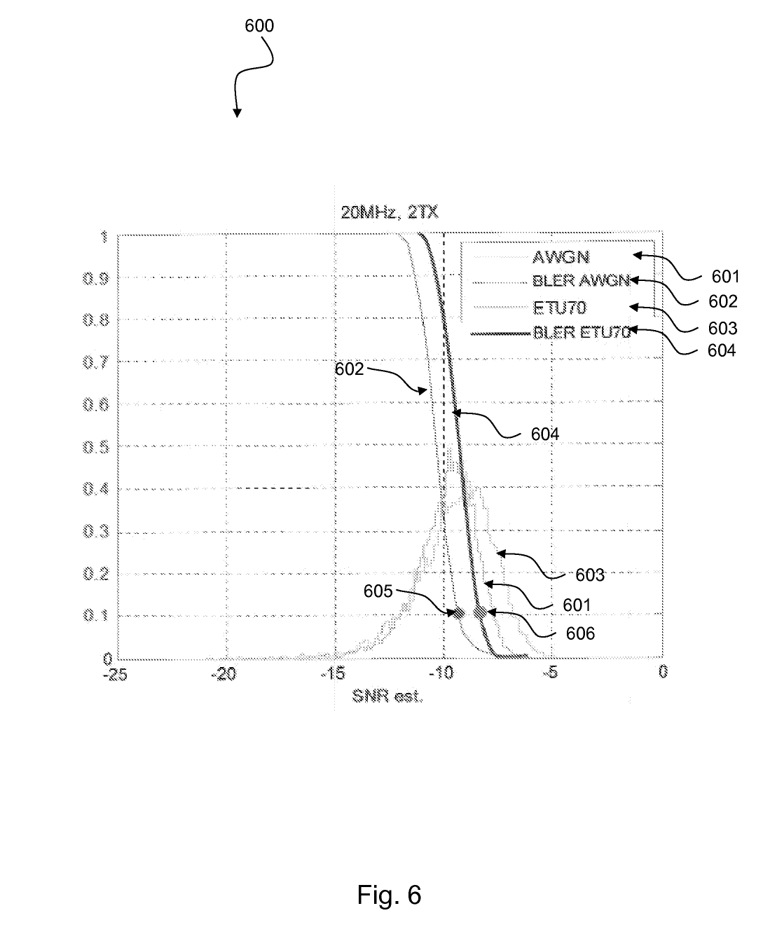

In one example, the method 100 comprises determining signal-to-noise ratios of at least one of a physical downlink control channel and a physical control format indicator channel as defined by LTE standardization. Such methods and devices are compliant to LTE systems. In one example, the method 100 comprises detecting a synchronization event if the average of the weighted sequence of signal-to-noise ratios of at least one of the physical downlink control channel and the physical control format indicator channel crosses a threshold. A logical OR combination can be used for detecting which channel crosses the threshold. The PDCCH and the PCFICH channels are important for control communication and therefore also for the purpose of determining synchronization. If at least one of these channels is no more received reliably, no communication can proceed reliably and therefore the connection is considered to be out-of-Sync. This can be rapidly detected by methods and devices using synchronization detection as presented in this disclosure. In one example, the method 100 comprises detecting a loss of synchronization state if the average of the weighted sequence of signal-to-noise ratios of the radio link falls below a threshold. The average value is more reliable than the instantaneous value; thus the method 100 shows a high reliability. In one example of the method 100 the threshold is predetermined. The threshold can be predetermined, e.g. by simulations as described below with respect to FIGS. 6 to 9. When predetermining the threshold, the computational complexity for implementing the method in a UE can be reduced. Devices using such a predetermined threshold are fast as no complex processing with respect to probability distributions is required.

In one example of the method 100 the threshold is stored in a lookup table. Storing the threshold in a lookup table is an efficient way to reduce computational complexity. One single memory cell may be enough for storing such a threshold. In one example of the method 100 the weighting function is monotonically falling within a predetermined range of signal-to-noise ratios. A monotonically falling weighting function provides the desired symmetry requirements. By transforming unsymmetrical distributions with a monotonically falling weighting function, the transformed distributions can show a better symmetry behavior than the original distributions. In one example of the method 100 the weighting function comprises a block error rate function of the sequence of signal-to-noise ratios. Such BLER functions show monotonically falling characteristics, e.g. waterfall-like shapes, and are therefore suitable for transforming distributions of different channels or channel models to a unique transformed distribution which can serve as basis for determining a single threshold.

In one example, the method 100 comprises measuring a block error rate over a signal-to-noise ratio for a multi-path fading channel. By measuring the BLER of a multi-path fading channel a BLER curve is obtained that can be used as a weighing function for the method 100. In one example, the method 100 comprises measuring a block error rate over a signal-to-noise ratio for one of the following channels as defined in 3GPP TS 36.101 V11.4.0: an AWGN channel, an ETU 30 Hz (ETU30) channel, an ETU 70 Hz (ETU70) channel, an ETU 300 Hz (ETU300) channel, an EVA 5 Hz (EVA5) channel, an EVA 70 Hz (EVA70) channel, an EPA 5 Hz (EPA5) channel, a high speed train channel, and an MBSFN channel to obtain the weighting function. Each of the BLER curves determined from the different channel models can be used as weighting function for the method. The BLER curves can be predetermined, e.g. by simulation as described below with respect to FIGS. 6 to 9. By predetermination, processing efforts can be shifted from real-time signal processing to the simulation phase.

In one example, the method 100 comprises multiplying each signal-to-noise ratio of the sequence of signal-to-noise ratios with a corresponding weight to obtain the weighted sequence of signal-to-noise ratios. The weighting function can be efficiently realized by a multiplication of the SNR values with a corresponding weight. In one example, the method 100 comprises accumulating elements of the weighted sequence of signal-to-noise ratios to obtain the average of the weighted sequence of signal-to-noise ratios. Multiplication and accumulation can be efficiently realized by an FIR filter. Therefore, an FIR filter can be used for implementing the method 100. Alternatively other functions can be used to calculate average values including running average. In one example, the method 100 comprises detecting a synchronization event if the average of the weighted sequence of signal-to-noise ratios of the radio link crosses a threshold, wherein the weighting function is monotonically falling within a predetermined range around the threshold. The average of the weighted SNR values is a reliable value. The range around the threshold is the characteristic range for the original and for the weighted distribution as within that range SNR values take their maximum and are notably effected by the weighting function. The threshold may be located for example in a range around 9 dB, or around 8 to 10 db or around 7 to 11 db or around 6 to 12 db or around 5 to 13 db or around 4 to 14 db or around 3 to 15 db or around 2 to 16 db or around 1 to 17 db.

In one example, the method 100 comprises detecting an out-of-sync state if the average of the weighted sequence of signal-to-noise ratios of the radio link falls below the threshold. When SNR values are too small, synchronization can not be provided. Therefore, using the average of the weighted sequence of signal-to-noise ratios as the value for performing a threshold decision results in a reliable and fast synchronization detection. In one example of the method 100 the threshold with respect to an out-of-sync event is defined for a block error rate of a first value. In one example of the method 100 the threshold with respect to an out-of-sync event is defined for a block error rate of a first value of 10 percent. By using a BLER of 10 percent for out-of-sync detection, the method 100 is compliant to LTE which applies such a threshold according to 3GPP TS 36.133 V11.4.0 chapter 7.6.1. In one example of the method 100 the threshold with respect to an out-of-sync event is defined for a block error rate of a first value of one of the following percentages: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95.

In one example of the method 100 the threshold with respect to an in-sync event is defined for a block error rate of a second value smaller than the first value. In one example of the method 100 the threshold with respect to an in-sync event is defined for a block error rate of a second value of 2 percent. By using a BLER of 2 percent for in-sync detection, the method 100 is compliant to LTE which applies such a threshold according to 3GPP TS 36.133 V11.4.0 chapter 7.6.1. In one example of the method 100 the threshold with respect to an in-sync event is defined for a block error rate of a second value of one of the following percentages: 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, 45, 50, 55, 60, 65, 70, 75, 80, 85, 90, 95.

In one example, the method 100 comprises determining the average of the weighted sequence of signal-to-noise ratios of the radio link according to the relation:

$$A = \frac{1}{K} {\sum }_{k = 0}^{K} SNR ( k ) \cdot w [ SNR ( k ) ] , \qquad ( 1 )$$

where A denotes the average, SNR(k) denotes the sequence of signal-to-noise ratios, k denotes an index of the sequence of signal-to-noise ratios, 0 and K are the borders of the sequence of signal-to-noise ratios and w denotes a weighting of the sequence of signal-to-noise ratios. Applying such a relation is easy to compute, e.g. by using an FIR filter or an accumulator. Alternate implementations using different variants of averaging (e.g. geometrical harmonic mean) are applicable as well.

The method 100 provides a robust solution to the classification problem mentioned above which does not depend on such a classification metric, but relies on a continuous analysis. The method 100 provides a continuous proof of the sync-loss or out-of-sync condition independent of the actual channel scenario.

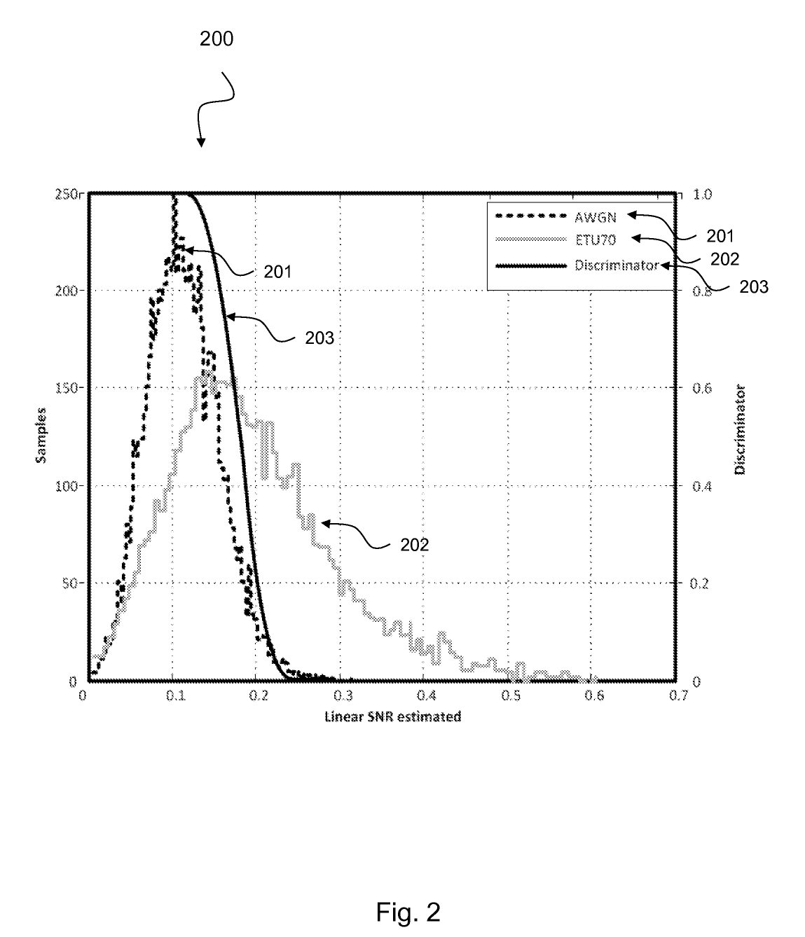

Referring to FIG. 2, a graph 200 depicting exemplary SNR distributions of an AWGN channel 201 and an ETU70 channel 202 and an exemplary weighting function 203 are shown. In both cases the average SINR is selected to correspond to a BLER of 10%. The graph 200 illustrates samples (left vertical axis) over linear SNR estimated (horizontal axis) for the two SNR distributions of the AWGN channel 201 and the ETU70 channel 202. The graph 200 illustrates discriminator value in the range between 0 and 1.0 (right vertical axis) over linear SNR estimated (horizontal axis) for the weighting function 203 which is also denoted as discrimination function or discriminator.

The SNR distribution of the AWGN channel 201 shows a characteristic SNR value at about 0.1 indicating an SNR maximum of the distribution. The SNR distribution is similar to a Gauss distribution where the characteristic value of maximum SNR corresponds to a mean value of the distribution and where the distribution is symmetrical around its mean value. The SNR distribution of the ETU70 channel 202 is not similar to a Gauss distribution and is not symmetrically distributed around a mean value. Instead, it is unsymmetrical distributed with a fast increasing left slope between zero and a characteristic SNR value where the distribution takes its maximum (around 0.13) and a low decreasing right slope between the characteristic SNR value and SNR values higher than the characteristic SNR value.

By weighting the two distributions 201, 202 with a weighting function, as described above with respect to FIG. 1, the unsymmetrical distribution of the ETU70 channel 202 can be transformed to an approximately symmetrical distribution which may coincide with the weighted distribution of the AWGN channel 201 such that the weighted SNR samples have almost the same values for each channel. The symmetrical distribution of the AWGN channel 201 is rarely influenced by the weighting.

Appropriate weighting functions are monotonically falling within a (characteristic) range of the characteristic SNR value and can have other shapes outside of that range. FIG. 2 shows one exemplary weighting function also denoted as discriminator 203. The weighting function 203 is monotonically falling within a characteristic range where the distribution of the ETU70 channel 202 takes its maximum. Elements of the distribution 202 arranged on the left slope are weighted by a weight around 1 and elements of the distribution 202 arranged on the right slope are weighted by a weight monotonically falling between 1 and 0. Therefore, the left slope maintains its steepness while the right slope is transformed to a slope of higher steepness similar to the left slope. In one example, the characteristic range includes all SNR values which are significantly greater than zero such that the monotonically falling behavior of the weighting function is applied to all SNR values significantly greater than zero.

The weighting function 203 can be a BLER curve or similar thereto, e.g. a BLER curve predetermined from simulations as described below with respect to FIGS. 6 to 9. The weighting function 203 can be any function that weights SNR values on the left slope with a higher weight than SNR values on the right slope in average. Even a non-monotonically falling function can be used which weights not all SNR values but only parts of the SNR values, e.g. up-sampled ones of the SNR values. The weighting function does not have to be falling over the whole (characteristic) range where the SNR values take their maximum. The weighting function may vary between falling sections and rising sections in the (characteristic) range as long as the overall behavior of the weighting function in the characteristic range is falling. The weighting function can have a “waterfall” shape, it can have a step-like shape or a multi-step-like shape, it can be linearly falling.

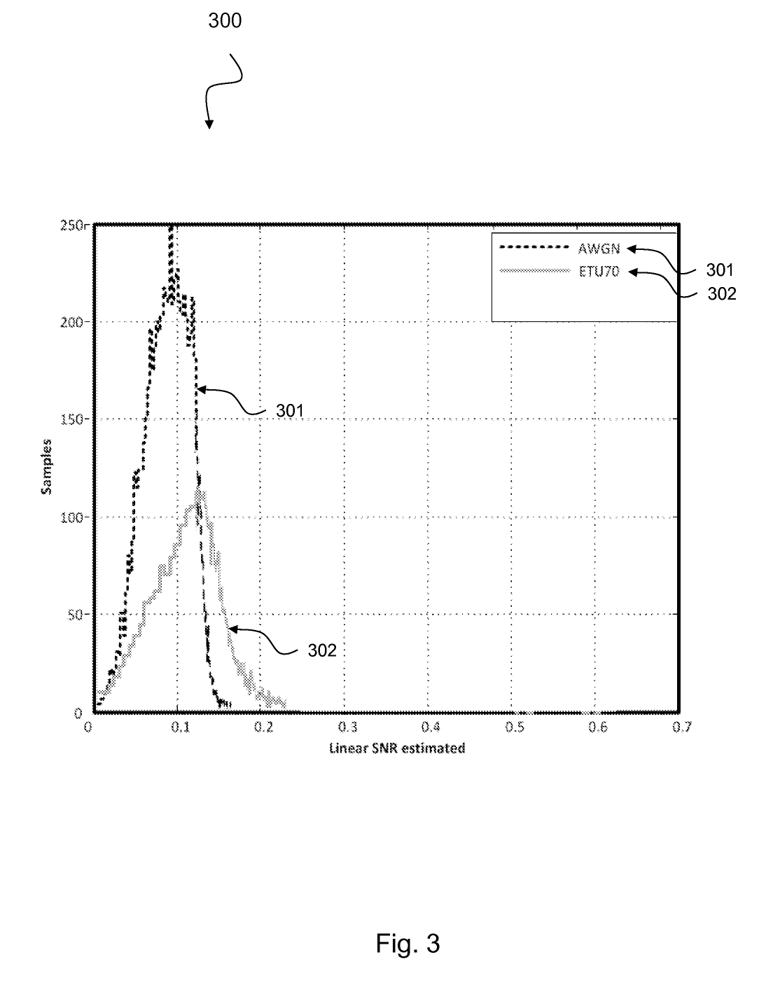

Applying the weighting function 203 to the two distributions 201, 202 results in weighted distributions as illustrated in FIG. 3 described below.

Referring to FIG. 3, a graph 300 depicting exemplary weighted SNR distributions of the AWGN channel 301 and the ETU70 channel 302 as depicted in FIG. 2 after the weighting with the weighting function is shown.

The weighted SNR distribution of the AWGN channel 301 is similar to the SNR distribution of the AWGN channel 201 as shown in FIG. 2 because the applied weighting function 203 is approximately one in the characteristic range where the SNR distribution of the AWGN channel 201 takes its maximum and is slowly decreasing with respect to higher SNR values. The weighted SNR distribution of the ETU70 channel 302 is transformed to a “Gauss-like” curve which has better symmetry properties than the original non-transformed SNR distribution 202. Both weighted distributions 301, 302 have nearly similar shapes such that an average of the weighted SNR distribution of the AWGN channel 301 is close to an average of the weighted SNR distribution of the ETU70 channel 302. This means, applying a method 100 as described above with respect to FIG. 1 results in a continuous approach to trigger SyncLoss state for multiple channel scenarios and without prior channel estimation.

The average value A_{AWGN} of the SNR distribution of the AWGN channel 201 can be determined according to the following relation:

$${A}_{AWGN} = \frac{1}{K} {\sum }_{k = 0}^{K} {SNR}_{AWGN} ( k ) \cdot w [ {SNR}_{AWGN} ( k ) ] , \qquad ( 2 )$$

where A_{AWGN} denotes the average value, SNR_{AWGN}(k) denotes the sequence of signal-to-noise ratios distributed according to the AWGN distribution 201 depicted in FIG. 2, k denotes an index of the sequence of signal-to-noise ratios, 0 and K denote the averaging range for the sequence of signal-to-noise ratios and w denotes the weighting function 203 as depicted in FIG. 2.

The average value A_{ETU70} of the SNR distribution of the ETU70 channel 202 can be determined according to the following relation:

$${A}_{ETU 70} = \frac{1}{K} {\sum }_{k = 0}^{K} {SNR}_{ETU 70} ( k ) \cdot w [ {SNR}_{ETU 70} ( k ) ] , \qquad ( 3 )$$

where A_{ETU70} denotes the average value, SNR_{ETU70}(k) denotes the sequence of signal-to-noise ratios distributed according to the ETU70 distribution 202 depicted in FIG. 2, k denotes an index of the sequence of signal-to-noise ratios, 0 and K denote the averaging range for the sequence of signal-to-noise ratios and w denotes the weighting function 203 as depicted in FIG. 2.

For computing of both average values A_{AWGN} and A_{ETU70} the same weighting function w is applied according to the illustration of FIG. 2. Both average values A_{AWGN} and A_{ETU70} are located close together at the respective SINR that corresponds to a predetermined BLER or may even coincide, even if the average SINR values for AWGN and ATU70 where the predetermined BLER occurs typically differ.

When using an appropriate weighting function which may be found by simulations as described below with respect to FIGS. 6 to 9, average values of different channels will fall together or will at least show a negligible remaining difference value. A resulting unique average of the transformed, i.e. weighted, SNR estimates can be used for a threshold decision with regard to a synchronization event. The UE can decide based on the transformed, i.e. weighted, SNR average value which is a function of the block error rate characteristic and the target block error rate threshold, e.g. 10% as defined by 3GPP, whether the PDCCH/PCFICH exceeds the 10% BLER to switch to the SyncLoss state.

A threshold for the transformed (weighted) SNR average value which may correspond to the target BLER at 10% may be stored in the UE, e.g. in the form of a look-up table. The SNR discriminator 203 as found by simulations or as set to predetermined values can similarly be stored or generated by calculations with predetermined or stored parameters in the UE.

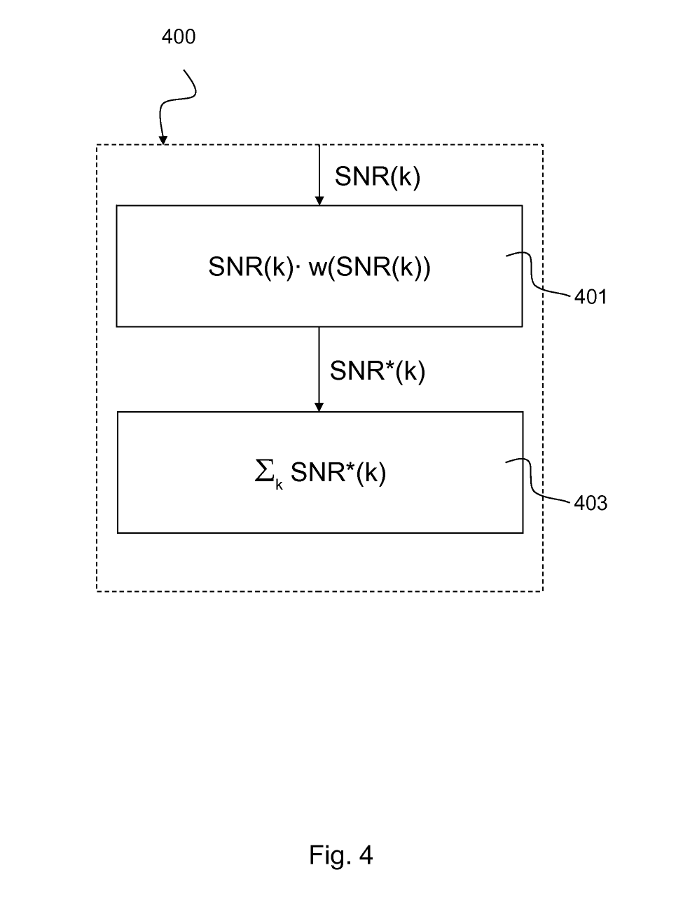

Referring to FIG. 4, an example of a radio link monitoring device 400 is shown. The radio link monitoring device 400 includes a weighting unit 401 which is configured for weighting a sequence of signal-to-noise ratios SNR(k) of the radio link with a weighting function w(SNR(k)) of the sequence of signal-to-noise ratios providing a weighted sequence of signal-to-noise ratios SNR*(k) of the radio link. The radio link monitoring device 400 includes a monitoring unit 403 which is configured for monitoring an average of the weighted sequence of signal-to-noise ratios SNR*(k) of the radio link. In an example the average is formed by accumulating elements of the weighted sequence of signal-to-noise ratios SNR*(k). In an example, the average is normalized, e.g. divided by the number of accumulated elements of the weighted sequence of signal-to-noise ratios SNR*(k) or divided by a power of the accumulated elements.

An exemplary radio link monitoring device 400 comprises a signal-to-noise ratio measuring unit configured for measuring the sequence of signal-to-noise ratios. An exemplary radio link monitoring device 400 comprises a storage unit configured for storing the weighting function. Alternatively a generation unit may be provided for generating the required values of the weighting function, e.g. calculating them from the signal-to-noise ratios.

An exemplary radio link monitoring device 400 comprises a first detection unit configured for detecting a synchronization event if the average of the weighted sequence of signal-to-noise ratios of the radio link crosses a threshold. An exemplary radio link monitoring device 400 comprises a first determining unit configured for determining the sequence of signal-to-noise ratios of the radio link based on a cell-specific reference signal. An exemplary radio link monitoring device 400 comprises a second determining unit configured for determining signal-to-noise ratios of at least one of a physical downlink control channel and a physical control format indicator channel as defined by LTE standardization. An exemplary radio link monitoring device 400 comprises a second detection unit configured for detecting a synchronization event if the average of the weighted sequence of signal-to-noise ratios of at least one of the physical downlink control channel and the physical control format indicator channel crosses a threshold. An exemplary radio link monitoring device 400 comprises a third detection unit configured for detecting a loss of synchronization state if the average of the weighted sequence of signal-to-noise ratios of the radio link falls below a threshold.

In an exemplary radio link monitoring device 400, the threshold is predetermined. In an exemplary radio link monitoring device 400, the threshold is stored in a lookup table. In an exemplary radio link monitoring device 400, the weighting function is monotonically falling within a predetermined range of signal-to-noise ratios. In an exemplary radio link monitoring device 400, the weighting function comprises a block error rate function of the sequence of signal-to-noise ratios.

An exemplary radio link monitoring device 400 comprises a block error rate measuring unit configured for measuring a block error rate over a signal-to-noise ratio for a multi-path fading channel, in particular for a multi-path fading channel model according to one of the following channel models as defined in 3GPP TS 36.101: AWGN, ETU 30 Hz, ETU 70 Hz, ETU 300 Hz, EVA 5 Hz, EVA 70 Hz, EPA 5 Hz, High speed train, and MBSFN to obtain the weighting function.

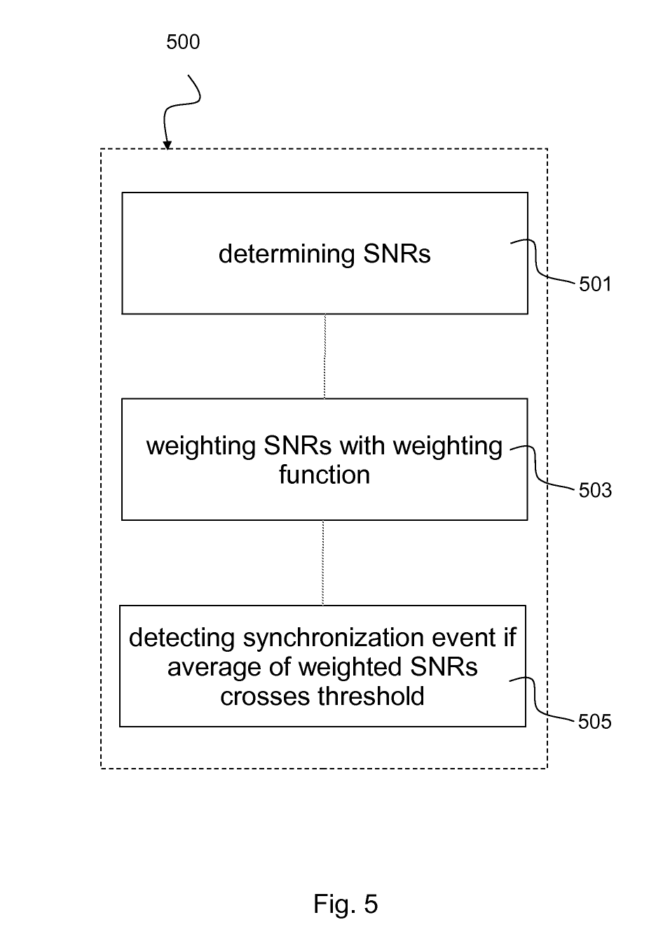

An exemplary radio link monitoring device 400 comprises a third determining unit configured for determining the average of the weighted sequence of signal-to-noise ratios of the radio link according to the above-mentioned relation:

$$A = \frac{1}{K} {\sum }_{k = 0}^{K} SNR ( k ) \cdot w [ SNR ( k ) ] , \qquad ( 1 )$$

where A denotes the average, SNR(k) denotes the sequence of signal-to-noise ratios, k denotes an index of the sequence of signal-to-noise ratios, 0 and K are the borders of the sequence of signal-to-noise ratios and w denotes a weighting of the sequence of signal-to-noise ratios. The radio link monitoring device 400 is configured to implement the method 100 described above with respect to FIG. 1 and the method 500 described below with respect to FIG. 5.

Referring to FIG. 5, a flow diagram of an exemplary method 500 for detecting synchronization events in a radio link is shown. The method 500 includes determining 501 a sequence of signal-to-noise ratios of the radio link. The method 500 includes weighting 503 the sequence of signal-to-noise ratios of the radio link with a weighting function. The method 500 includes detecting 505 a synchronization event if an average of the weighted sequence of signal-to-noise ratios of the radio link crosses a threshold.

In an example of the method 500, the weighting function depends on the sequence of signal-to-noise ratios. In an example, the method 500 comprises accumulating the weighted sequence of signal-to-noise ratios to obtain the average of the weighted sequence of signal-to-noise ratios. In an example of the method 500, the weighting function (w(SNR(k))) is monotonically falling within a predetermined range around the threshold. In an example, the method 500 comprises detecting an out-of-sync state if the average of the weighted sequence of signal-to-noise ratios of the radio link falls below the threshold. In an example of the method 500, the threshold with respect to an out-of-sync event is defined for a block error rate of a first value, in particular a first value of 10 percent. In an example of the method 500, the threshold with respect to an in-sync event is defined for a block error rate of a second value smaller than the first value, in particular a second value of 2 percent.

In an example, the method 500 comprises determining the sequence of signal-to-noise ratios of the radio link based on a cell-specific reference signal. In an example, the method 500 comprises determining signal-to-noise ratios of at least one of a physical downlink control channel and a physical control format indicator channel as defined by LTE standardization. In an example, the method 500 comprises detecting a synchronization event if the average of the weighted sequence of signal-to-noise ratios of at least one of the physical downlink control channel and the physical control format indicator channel crosses a threshold. In an example, the method 500 comprises detecting a loss of synchronization state if the average of the weighted sequence of signal-to-noise ratios of the radio link falls below a threshold. In an example of the method 500, the threshold is predetermined, in particular stored in a lookup table. In an example of the method 500, the weighting function is monotonically falling within a predetermined range of signal-to-noise ratios. In an example of the method 500, the weighting function comprises a block error rate function of the sequence of signal-to-noise ratios.

In an example, the method 500 comprises measuring a block error rate over a signal-to-noise ratio for a multi-path fading channel, in particular for a multi-path fading channel model according to one of the following channel models as defined in 3GPP TS 36.101: AWGN, ETU 30 Hz, ETU 70 Hz, ETU 300 Hz, EVA 5 Hz, EVA 70 Hz, EPA 5 Hz, High speed train, and MBSFN to obtain the weighting function. In an example, the method 500 comprises determining the average of the weighted sequence of signal-to-noise ratios of the radio link according to the above-mentioned relation:

$$A = \frac{1}{K} {\sum }_{k = 0}^{K} SNR ( k ) \cdot w [ SNR ( k ) ] , \qquad ( 1 )$$

where A denotes the average, SNR(k) denotes the sequence of signal-to-noise ratios, k denotes an index of the sequence of signal-to-noise ratios, 0 and K are the borders of the sequence of signal-to-noise ratios and w denotes a weighting of the sequence of signal-to-noise ratios.

The method 500 provides a robust solution to the classification problem mentioned above which does not depend on such a classification metric, but relies on a continuous analysis. The method 500 provides a continuous proof of the sync-loss or out-of-sync condition independent of the actual channel scenario.

Referring to FIG. 6, a graph 600 depicting exemplary SNR distributions of an AWGN channel 601 and an ETU70 channel 603 and exemplary block error rates (BLER) of the AWGN channel 602 and the ETU70 channel 604 are shown.

The Out-of-Sync state (SyncLoss) is triggered by the logical OR function of the two physical channels PDCCH (physical downlink control channel) and PCFICH (physical control format indicator channel) with respect to their SNR-to-BLER curves at a defined BLER-to-SNR point. A 2 TX antennas configuration is used with 20 MHz LTE system bandwidth and the two channel scenarios of AWGN and ETU70. The histograms for AWGN channel 601 and ETU70 channel 603, i.e. simulated probability density functions of the estimated SINR are illustrated for the AWGN channel at the 10% BLER(AWGN) working point 605 and for the ETU70 channel at the 10% BLER(ETU70) working point 606. If a defined number of such BLER-SNR events is exceeded, the SyncLoss condition is flagged. This BLER-SNR point, e.g. 10% BLER at 8 dB, changes with the applied channel condition. The scale of the vertical axis ranging from 0 to 1 corresponds to the block error rate probability of the BLER curves 602, 604. The distributions of AWGN channel 601 and ETU70 channel 603 are not related to that vertical scale, a similar scale as depicted in FIG. 2 (left vertical axis) applies for these distributions.

The problem of a priori channel scenario detection and associated classification is overcome by continuously preprocessing the estimated SINR resulting in a single BLER-to-SNR point for different channel scenarios. By applying the method 100 as described above with respect to FIG. 1 or the method 500 as described above with respect to FIG. 5, a single BLER curve is used as weighting function for both channel scenarios, which results in the same SyncLoss behavior. In one example, the BLER curve of the AWGN channel 602 is used as weighting function. In one example, the BLER curve of the ETU70 channel 604 is used as weighting function.

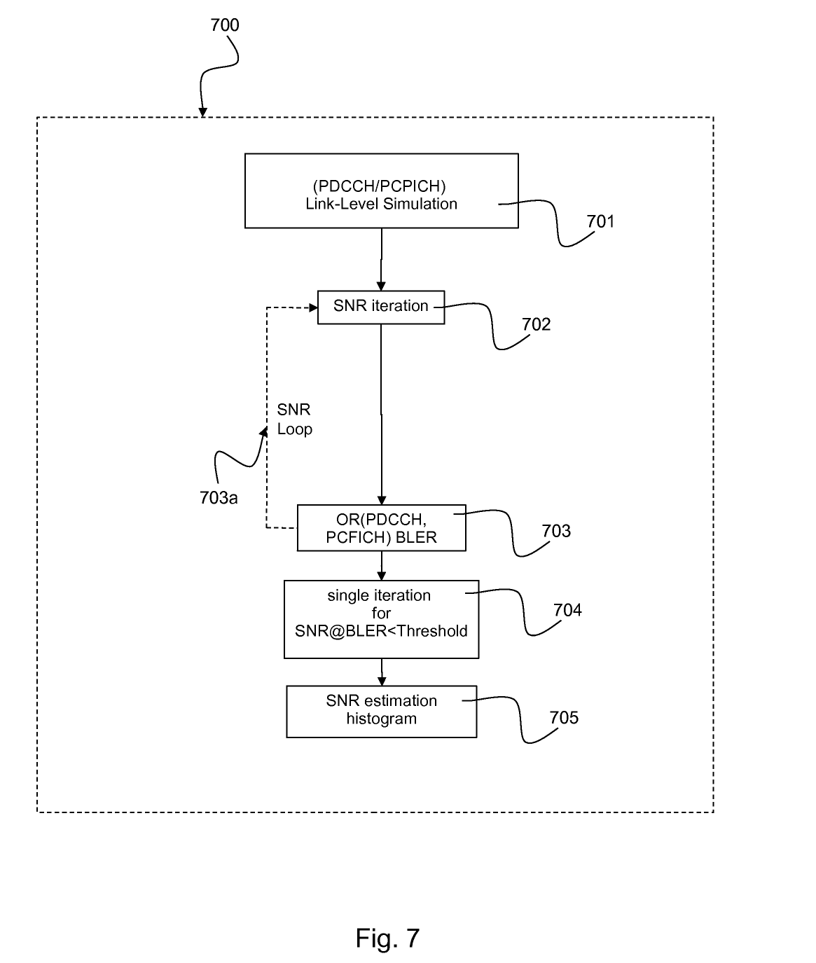

The major step in the methods 100, 500 for radio link monitoring is the estimation of the actual SINR condition of the UE receiver, e.g. the SINR condition of the PDCCH/PCFICH channels. In one example, the SINR estimation uses the cell-specific reference signal (CRS) and has a distribution and variance for each BLER-to-SNR point, which depends on the underlying channel scenario. This is the starting point for generating the SNR distributions and block error rates. SNR refers to the configured SNR for the respective simulation, whereas the estimated SINR is a noisy estimate for any particular SNR iteration as described below with respect to FIG. 7.

Referring to FIG. 7, a flow diagram of an exemplary method 700 for generating SNR distributions and block error rates is shown. The block error rates can be used as weighting functions for the methods 100, 500 as described above with respect to FIGS. 1 and 5. The SNR distributions describe possible values of SNRs which SNRs can be used as input values for the methods 100, 500. The method 700 can be applied for simulating or pre-processing an appropriate BLER curve serving as weighting function for the methods 100, 500 or for the device 400.

In a first step 701, a link-level simulation of PDCCH/PCPICH channels is performed. In a second step 702 after the link-level simulation step 701, an SNR iteration is performed for the PDCCH/PCPICH channels and in a third step 703 block error rates of the PDCCH/PCPICH channels are determined for the corresponding SNR values. The SNR values are varied within a predetermined bandwidth of SNR values, for example from a lower SNR value of −25 dB to an upper SNR value of 0 dB as shown in FIG. 6. In one example, multiple CRS values or pilot signal values, e.g. a number of about 10.000 CRS values or pilot signal values are used for generating one SNR value of the sequence of SNR values. The variation of SNR values within the said bandwidth is described by the SNR loop 703a depicted in FIG. 7. In a fourth step 704 a single SNR iteration is performed for detecting if the SNR at a target BLER, for example a target BLER of 10% falls below a threshold. In a fifth step 705, the SNR estimation histogram is produced.

The AWGN distribution is something like an optimum distribution for a mobile channel as only (symmetrical distributed) background noise disturbs transmission. Other channels, e.g. channels experiencing multi-path fading or Doppler spread, are degrading the distribution properties such that the distribution is broadened and less symmetric, i.e. showing a steeper left slope and a less steep right slope.

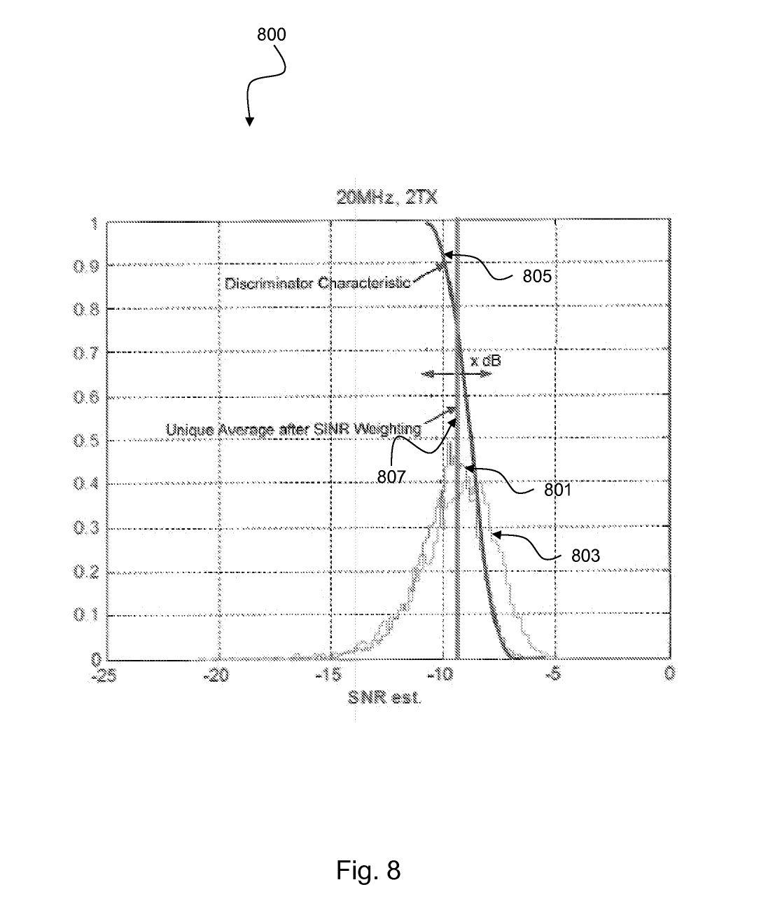

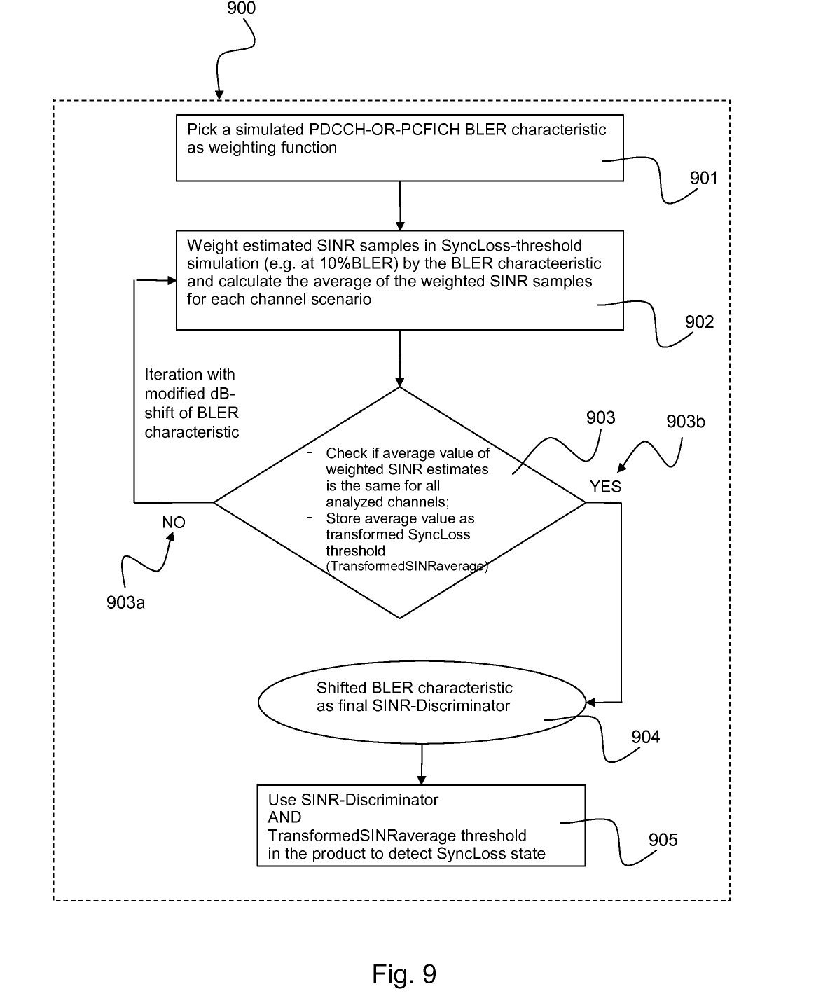

Referring to FIG. 8, a graph 800 depicting exemplary SNR distributions of an AWGN channel 801 and an ETU70 channel 803, an exemplary block error rate 805 used as weighting function, also denoted discriminator characteristic and an exemplary average after weighting 807 are shown. A simulation method according to FIGS. 8 and 9 can be used for pre-processing the weighting function and/or the threshold as described above with respect to FIGS. 1 to 5.

The BLER characteristic 805, which weights the SINR estimates of both AGWN 801 and ETU70 803 distributions individually, is shifted by x dB until the average value of the weighted SINR estimates for each channel scenario result is identical as can be seen from FIG. 8. This average value finally triggers the SyncLoss state in the UE. The weighting function is hereinafter also called SNR-discriminator, because it transforms the distribution of the instantaneous channel-dependent SINR estimates, i.e. it discriminates high SINR values.

The shifted BLER characteristic, which provides the same average value (“Unique Average after SINR Weighting”, 807) of the weighted SINR estimates for all channels in the set corresponds to the final SINR-discriminator. This corresponds to a transformation of the probability density function of the SINR estimates. While FIG. 8 depicts an exemplary configuration of two channels (e.g. AWGN and ETU70), other channel configurations with other channels or more channels will show same or similar results.

The relation between the weighted SINR average for the two channels channel_{—}1, e.g. AWGN and channel_{—}2, e.g. ETU70 can be expressed by the following equation system:

$$TransformedSINRaverage ( {BLER}_{characteristic} , {BLER}_{threshold ( 10 \% )} ) = \frac{1}{K} {\sum }_{k = 0}^{K} {BLER}_{characteristic} ( k ) \cdot {SINR ( k , channel\_ 1 )}_{EstimatedSample} = \frac{1}{K} {\sum }_{k = 0}^{K} {BLER}_{characteristic} ( k ) \cdot {SINR ( k , channel\_ 2 )}_{EstimatedSample} + Δ δ \\ Δ δ {}^{{BLER}_{characteristic} = SINR - Discriminator} 0 \qquad ( 4 )$$

If the BLER characteristic is shifted correctly, the remaining difference Δδ tends to a negligible value or to zero. The resulting unique average of the transformed SINR estimate is depicted as the vertical line 807 in FIG. 8.

The UE can decide based on the TransformedSINRaverage value of equation (4), which is a function of the BLER_{characteristic} and the target BLER_{threshold(10%)}, whether the PDCCH/PCFICH exceeds the 10% BLER according to 3GPP TS 36.133 to switch to the SyncLoss state as described below with respect to FIG. 9. The TransformedSINRaverage threshold, which corresponds to the target BLER(10%) to detect SyncLoss state, and the SINR-Discriminator that can be found by simulations may be stored in the product, e.g. as look-up table. The Transformed SINRaverage threshold corresponds to the formal PDCCH/PCFICH BLER threshold, for which SyncLoss state is detected according to FIG. 9, last box 905.

Referring to FIG. 9, a flow diagram of an exemplary method 900 for generating a threshold for detection of synchronization events is shown. The method 900 can be used for pre-processing the weighting function and/or the threshold as described above with respect to FIGS. 1 to 5.

In a first step 901, a simulated PDCCH-OR-PCFICH BLER characteristic, i.e. a characteristic of the PDCCH channel combined by a logical OR operation with a characteristic of the PCFICH channel, is picked as weighting function. In a second step 902 after the first step 901, the estimated SINR samples are weighted in a SyncLoss-threshold simulation (e.g. at 10% BLER) by the BLER characteristic and the average of the weighted SINR samples is calculated for each channel scenario. In a third step 903 thereafter, it is checked if the average value of the weighted SINR estimates is the same for all analyzed channels and the average value is stored as transformed SyncLoss threshold (TransformedSINRaverage). If the check is negative 903a, an iteration with modified dB-shift of the BLER characteristic is repeated. If the check is positive 903b, in a fourth step 904, the shifted BLER characteristic is used as final SINR-Discriminator and in a fifth step 905 thereafter, the SINR-Discriminator and the TransformedSINRaverage threshold combined by a logical AND operation are used in the product to detect the SyncLoss state.

The variable “SINR-Discriminator” describes the weighting function described above with respect to FIGS. 1 to 5. The variable “TransformedSINRaverage” describes the average of the weighted sequence of signal-to-noise ratios described above with respect to FIGS. 1 to 5. The variable BLER_{characteristic} describes the block error rate characteristic with respect to the used channel or channel model, e.g. a BLER function 602, 604 as depicted above in FIG. 6. The variable BLER_{threshold(10%)} describes the characteristic point of the BLER curve for which SNR a block error rate of 10% is reached, e.g. a point 605, 606 as depicted in FIG. 6. The characteristic point can be used as a threshold for detecting a synchronization event such as an out-of-sync as described above with respect to FIGS. 1 to 5.

Aspects of the disclosure apply a set of channel scenarios, which is known a priori and for which the BLER curves as well as the SNR distribution has been analyzed as described with respect to FIGS. 6 and 7. The concept is to weight the estimated SINR samples with the same weighting function for any channel in the channel set. The weighting function may have a BLER-like slope, e.g. one of the channel BLER result plots can be used as unique weighting characteristic for all channels' SINR samples. The goal is to transform the SINR estimates of each channel in the set such that the transformed-SINR samples average has (almost) the same value for all channels. This means a continuous approach to trigger SyncLoss state for multiple channel scenarios and without prior channel estimation.

Aspects of the disclosure reduce the complexity of the SyncLoss detection in the UE as part of the Radio Link Monitoring framework. Aspects of the disclosure lead to a continuous SyncLoss detection method with respect to the underlying channel scenario. The SyncLoss detection as presented here detects the SyncLoss without significant (time) delay. In an alternative implementation a priori channel classification based on CRS information is used or is additionally used for generating the SNR average value. In a further alternative implementation, the PDCCH BLER threshold is directly used to identify the SyncLoss.

While the disclosure illustrates and describes one or more implementations, alterations and/or modifications may be made to the illustrated examples without departing from scope of the appended claims. In particular regard to the various functions performed by the above described components or structures (assemblies, devices, circuits, systems, etc.), the terms (including a reference to a “means”) used to describe such components are intended to correspond, unless otherwise indicated, to any component or structure which performs the specified function of the described component (e.g., that is functionally equivalent), even though not structurally equivalent to the disclosed structure which performs the function in the herein illustrated exemplary implementations.

Although the elements in the following claims are recited in a particular sequence with corresponding labeling, unless the claim recitations otherwise imply a particular sequence for implementing some or all of those elements, those elements are not necessarily intended to be limited to being implemented in that particular sequence.

What is claimed is:

1. A method for radio link monitoring, the method comprising:
weighting a sequence of signal-to-noise ratios of a radio link with a weighting function of the sequence of signal-to-noise ratios; and
monitoring an average of the weighted sequence of signal-to-noise ratios of the radio link.

2. The method of claim 1, comprising:
detecting a synchronization event if the average of the weighted sequence of signal-to-noise ratios of the radio link crosses a threshold.

3. The method of claim 1, comprising:
determining the sequence of signal-to-noise ratios of the radio link based on a cell-specific reference signal.

4. The method of claim 1, comprising:
determining signal-to-noise ratios of at least one of a physical downlink control channel and a physical control format indicator channel as defined by LTE standardization.

5. The method of claim 4, comprising:
detecting a synchronization event if the average of the weighted sequence of signal-to-noise ratios of at least one of the physical downlink control channel and the physical control format indicator channel crosses a threshold.

6. The method of claim 1, comprising:
detecting a loss of synchronization state if the average of the weighted sequence of signal-to-noise ratios of the radio link falls below a threshold.

7. The method of claim 6, wherein the threshold is predetermined and stored in a lookup table.

8. The method of claim 1, wherein the weighting function is monotonically falling within a predetermined range of signal-to-noise ratios.

9. The method of claim 1, wherein the weighting function comprises a block error rate function of the sequence of signal-to-noise ratios.

10. The method of claim 9, comprising:
measuring a block error rate over a signal-to-noise ratio for a multi-path fading channel model according to one of the following channel models as defined in 3GPP TS 36.101:
AWGN,
ETU 30 Hz,
ETU 70 Hz,
ETU 300 Hz,
EVA 5 Hz,
EVA 70 Hz,
EPA 5 Hz,
High speed train, and
MBSFN
to obtain the weighting function.

11. The method of claim 1, comprising:
determining the average of the weighted sequence of signal-to-noise ratios of the radio link according to the relation:
$$A = \frac{1}{K} {\sum }_{k = 0}^{K} SNR ( k ) \cdot w [ SNR ( k ) ] ,$$
where A denotes the average, SNR(k) denotes the sequence of signal-to-noise ratios, k denotes an index of the sequence of signal-to-noise ratios, 0 and K are the borders of the sequence of signal-to-noise ratios, and w denotes a weighting of the sequence of signal-to-noise ratios.

12. A radio link monitoring device, comprising:
a weighting unit configured for weighting a sequence of signal-to-noise ratios of a radio link with a weighting function of the sequence of signal-to-noise ratios; and
a monitoring unit configured for monitoring an average of the weighted sequence of signal-to-noise ratios of the radio link.

13. The radio link monitoring device of claim 12, comprising:
a signal-to-noise ratio measuring unit configured for measuring the sequence of signal-to-noise ratios.

14. The radio link monitoring device of claim 12, comprising at least one of:
a storage unit configured for storing the weighting function, and
a generation unit configured for generating the weighting function.

15. A method for detecting synchronization events in a radio link, the method comprising:
determining a sequence of signal-to-noise ratios of the radio link;
weighting the sequence of signal-to-noise ratios of the radio link with a weighting function; and
detecting a synchronization event if an average of the weighted sequence of signal-to-noise ratios of the radio link crosses a threshold.

16. The method of claim 15, wherein the weighting function depends on the sequence of signal-to-noise ratios.

17. The method of claim 15, comprising:
accumulating the weighted sequence of signal-to-noise ratios to obtain the average of the weighted sequence of signal-to-noise ratios.

18. The method of claim 15, wherein the weighting function monotonically falls within a predetermined range around the threshold.

19. The method of claim 15, comprising:
detecting an out-of-sync state if the average of the weighted sequence of signal-to-noise ratios of the radio link falls below the threshold.

20. The method of claim 15,
wherein the threshold with respect to an out-of-sync event corresponds to a block error rate of a first value of 10 percent; and
wherein the threshold with respect to an in-sync event corresponds to a block error rate of a second value of 2 percent.
